(19) United States
(12) Patent Application Publication
(10) Pub. No.: US 2010/0218385 A1
(43) Pub. Date: Sep. 2, 2010

(54) Battery-Operated Hand-Held Electric Device

(75) Inventors: Harald Mang, Winnenden (DE); Matthias Müller, Remshalden (DE); Volker Reber, Michelbach (DE)

Correspondence Address: GUDRUN E. HUCKETT DRAUDT, SCHUBERTSTR. 15A, WUPPERTAL, 42289, DE

(73) Assignee: Andreas Stihl AG & Co. KG, Waiblingen (DE)

(21) Appl. No.: 12/709,532

(22) Filed: Feb. 22, 2010

(30) Foreign Application Priority Data
Feb. 27, 2009 (DE) 10 2009 012 177.3

(51) Int. Cl. A01G 3/053

(52) U.S. Cl. 30/216; 30/298

(57) ABSTRACT

A hand-guided electric device has an electric motor for driving a tool. The electric motor has a motor housing with inlet and outlet for cooling air. A blower wheel is driven by the electric motor and cooling air is conveyed into the motor housing with the blower wheel through the inlet and blown out from the motor housing through the outlet. The device housing has a cooling air inlet chamber and a cooling air outlet chamber. The cooling air enters the inlet chamber through a cooling air inlet port in an exterior housing wall of the device housing and exits from the outlet chamber through a cooling air outlet port in the exterior housing wall. The cooling air inlet and outlet chambers are separated from one another substantially air-tightly by an inner housing wall so that motor housing is the only flow connection between inlet and outlet chambers.

### BACKGROUND OF THE INVENTION

The invention relates to a hand-held electric device, in particular a hand-held power tool such as a hedge trimmer, a motor chain saw, a brush or grass trimmer or the like, in which an electric motor to be controlled by an electric component is arranged in a device for driving a working tool, wherein the electric motor takes in cooling air by means of a blower wheel into a motor housing and blows the cooling air out of the motor housing through an outlet opening. The cooling air flows into a cooling air inlet chamber within the device housing through a cooling air inlet port in the exterior wall of the device housing and exits the device housing from a cooling air outlet chamber provided within the device housing through a cooling air outlet port in the exterior wall of the device housing.

GB 1 120 728 discloses a power cord-based electric hedge trimmer with an electric motor that is arranged in a tower-shaped housing. Within the housing tower a cooling air inlet chamber is formed from where the electric motor takes in cooling air into its motor housing by means of blower wheel. Through an outlet opening at the opposite end of the motor housing the cooling air is blown out into a cooling air outlet chamber that is vented through an annular gap to the environment. Since the cooling air inlet chamber and the cooling air outlet chamber are arranged both within the bell-shaped device housing, it is possible that the cooling air will short-circuit under unsatisfactory operating conditions. For example, when the cooling air supply to the cooling air inlet chamber is hindered, the electric motor will take in its cooling air from the cooling air outlet chamber through the bell-shaped housing; this leads to impermissible temperature increase of the electric drive motor in operation.

### SUMMARY OF THE INVENTION

It is an object of the present invention to provide a hand-guided electric device of the aforementioned kind in such a way that an effective cooling action even under unfavorable operating conditions is ensured.

In accordance with the present invention, this is achieved in that the cooling air inlet chamber and the cooling air outlet chamber are air-tightly separated from one another to a large extent by means of an interior housing wall and in that the motor housing of the electric motor constitutes the only distinct flow connection between the cooling air inlet chamber and the cooling air outlet chamber.

By air-tightly separating to a large extent the cooling air inlet chamber and the cooling air outlet chamber from one another, is largely prevented that heated air is taken in from the cooling air outlet chamber. The motor housing of the electric motor forms the only distinct flow connection between the two chambers so that, even under unfavorable operating conditions, a cooling air flow connection between cooling air inlet chamber and cooling air outlet chamber is enforced. In this context, the structurally provided only distinct flow connection is to be understood such that substantially the entire cooling air flow flows through this flow connection and possibly occurring leakage flows are insignificantly small.

Preferably, the cooling air inlet port and the cooling air outlet port in the exterior wall of the device housing form a common port array wherein this common port array is divided by an inner housing wall that rests against an interior side of the exterior wall of the device housing. In this connection, the division is provided such that the incoming cooling air and the outflowing cooling air have the same flow orientation wherein the two flows are positioned at an angle of approximately 90° to 130° relative to one another.

The device housing has a longitudinal axis wherein on each one of the longitudinal sides of the device housing a cooling air inlet port and/or cooling air outlet port is arranged. In this way, it is ensured that the cooling air inlet chamber is supplied through two cooling air inlet ports so that even under unfavorable operating conditions a satisfactory cooling air intake is ensured. The two outlet ports provided on the longitudinal sides of the device housing ensure in the same way a disruption-free outflow of the heated cooling air.

In a preferred embodiment, the motor housing has two outlet openings wherein each outlet opening has correlated therewith an outlet port in the device housing. Even though both outlet openings open into a common cooling air outlet chamber, the stream of blown-out air is oriented such that the first outlet opening blows out substantially through a first cooling air outlet port on a first longitudinal side of the device housing and the second outlet opening blows out substantially through a second cooling air outlet port on the opposite second longitudinal side of the housing.

Preferably, the device housing is comprised of a top housing shell and a bottom housing shell wherein the cooling air inlet port(s) and the cooling air outlet port(s) are provided in the upper housing shell. The cooling air inlet chamber is delimited by the exterior wall of the device housing and the inner housing wall wherein the inner housing wall is a part of an air guiding hood that is expediently attached to the electric motor. The air guiding hood has a bottom in which the intake opening of the blower wheel is located.

In a further embodiment of the invention, a heat exchanger for an electric component for controlling the electric motor is disposed in the flow path of the cooling air between the inlet port and the outlet port. Expediently, the heat exchanger is positioned within the cooling air outlet chamber, in particular in the stream of outflowing air of an outflow opening of the motor housing.

### BRIEF DESCRIPTION OF THE DRAWING

FIG. 1 is side view of a hand-guided electric device embodied as a hedge trimmer.

FIG. 2 is a schematic view of the flow path of the cooling air in the device housing of a hedge trimmer according to FIG. 1.

FIG. 3 is a perspective, partially sectioned view of a hedge trimmer according to FIG. 1.

FIG. 4 is a plan view onto the hedge trimmer according to FIG. 3.

FIG. 5 is a side view of the hedge trimmer according to FIG. 1 with removed top housing shell.

FIG. 6 is a front view of the hedge trimmer according to FIG. 5.

FIG. 7 is a view of the air guiding hood in a bottom view.

FIG. 8 is a side view of the air guiding hood according to FIG. 7.

FIG. 9 is a schematic exploded view of the hedge trimmer according to FIG. 1.

### DESCRIPTION OF THE PREFERRED EMBODIMENTS

The hand-guided electric device as shown in the drawing is in particular a portable hand-guided power tool that will be explained with the aid of a hedge trimmer 1 being used as an example. The hand-guided power tool can also be a motor chain saw, a cut-off machine, a grass or brush trimmer, an edger, a pole pruner, a blower, a sprayer, a vacuuming device, an earth auger, a combination motor device for multi-functional attachments, a sweeper, a rotary hoe, a rototiller (cultivator), a high-pressure cleaning device, a lawnmower, a dethatcher, a chopper or shredder, a wet/dry vacuuming device or a similar power tool.

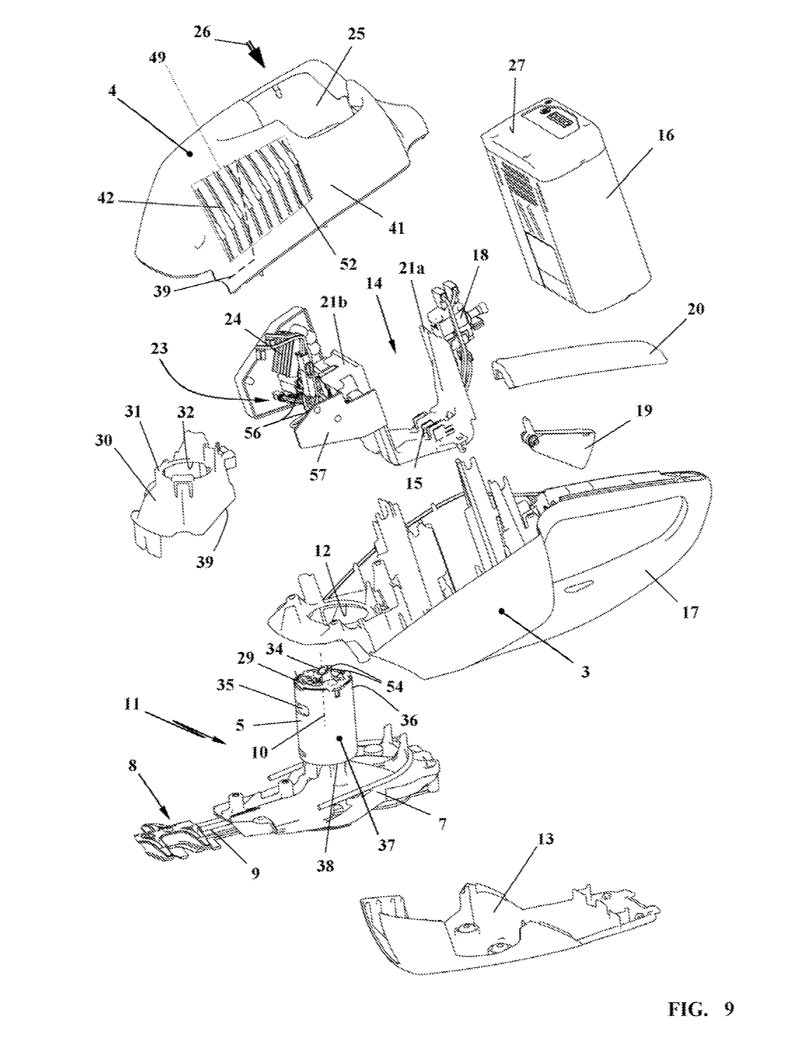

The illustrated hand-guided electric device comprises a device housing 2 that, as shown in particular in FIG. 9, is substantially comprised of a bottom housing shell 3 and a top housing shell 4. In the device housing 2, as shown in particular in FIGS. 2 through 4, an electric motor 5 is disposed that may be in particular a brushless high-performance motor. Such a brushless electric motor 5 requires for its operation an appropriate electronic control 23 that is arranged in FIG. 2 on a circuit board 6.

The electric motor 5 drives by means of a gear 7 (FIG. 9), only schematically shown, a working tool 8 of the power tool; in the illustrated embodiment this is a cutter bar 9 with reciprocating cutting blades.

As can be seen in the Figures, the axis of rotation 10 of the electric motor 5 is approximately perpendicular to the plane that is defined by the cutter bar 9.

The gear 7, the cutter bar 9, and the electric drive motor 5 together form an assembly 11 on which is secured the device housing 2 comprised of the bottom housing shell 3 and the top housing shell 4. As shown in FIG. 9, the bottom housing shell 3 is placed onto the assembly 11 of gear 7, cutter bar 9, and electric motor 5 wherein the electric motor 5 extends through a receiving opening 12 of the bottom housing shell 3 and in this way is positioned inside the device housing 2. After positioning the bottom housing shell 3, a bottom part 13 is secured on the opposite side of the assembly 11 and covers the gear 7 completely in the downward direction so that only the cutter bar 9 projects forwardly out of the device housing 2.

Into the bottom housing shell 3 a U-shaped battery pack support 14 is inserted from above; it is provided at its bottom with contacts 15 for a battery pack 16 that is insertable into the battery pack support 14.

As shown clearly in FIG. 9, the battery pack support 14 is provided at its legs 21a, 21b with different components of the electric device. On one leg 21a that is facing the rear grip 17 an engine speed adjuster 18 is secured that is to be actuated by means of a throttle lever 19 positioned in the upper part of the rear grip 17 in a pivotable way. The rear grip 17 is covered by a top grip shell 20.

The opposite leg 21b of the battery pack support 14 also constitutes a partition relative to a motor compartment 22 that is formed between the battery support 14 and the working tool 8 of the power tool. The motor compartment 22 is thus delimited by the bottom housing shell 3, the leg 21b of the battery pack support 14, and the top housing shell 4.

The leg 21b supports the electronic control 23 for operating the electric motor 5 that in the illustrated embodiment is embodied as a brushed rotor motor wherein the electronic control 23 is located in the motor compartment 22. As shown in FIG. 9, a heat exchanger 24 that is preferably embodied as a cooling member is provided on the longitudinal side 47 of the motor compartment 22 while on the opposite longitudinal side 48 further electronic components of the electronic control 23 are arranged.

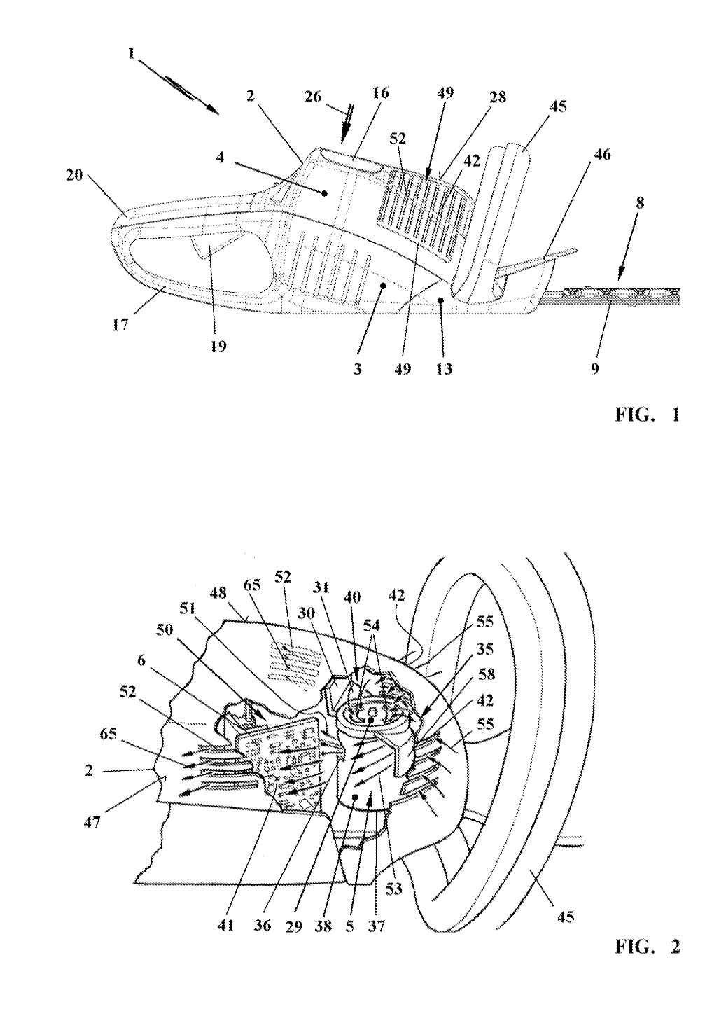

The top housing shell 4 has an insertion opening 25 for the battery pack 16 so that the battery pack 16, as shown in FIG. 1, is inserted from above in the direction of arrow 26 into the device housing 2. As shown in FIG. 1, the upper end face 27 of the battery pack 16 in the inserted operating position according to FIG. 1 is positioned approximately in a common plane with the housing topside 28 of the device housing 2.

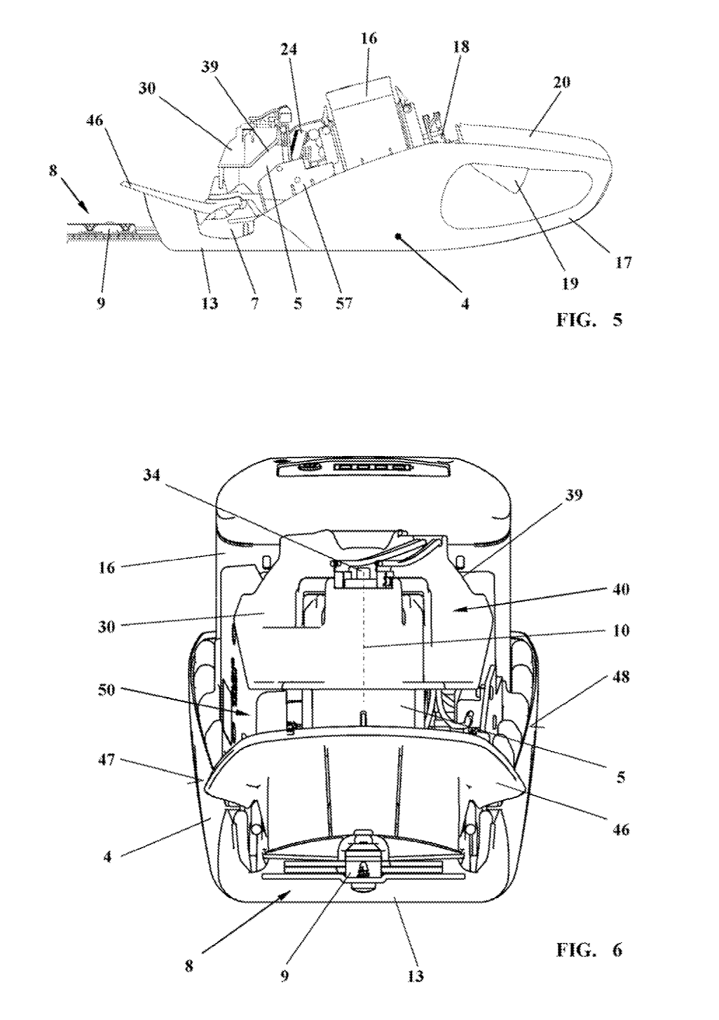

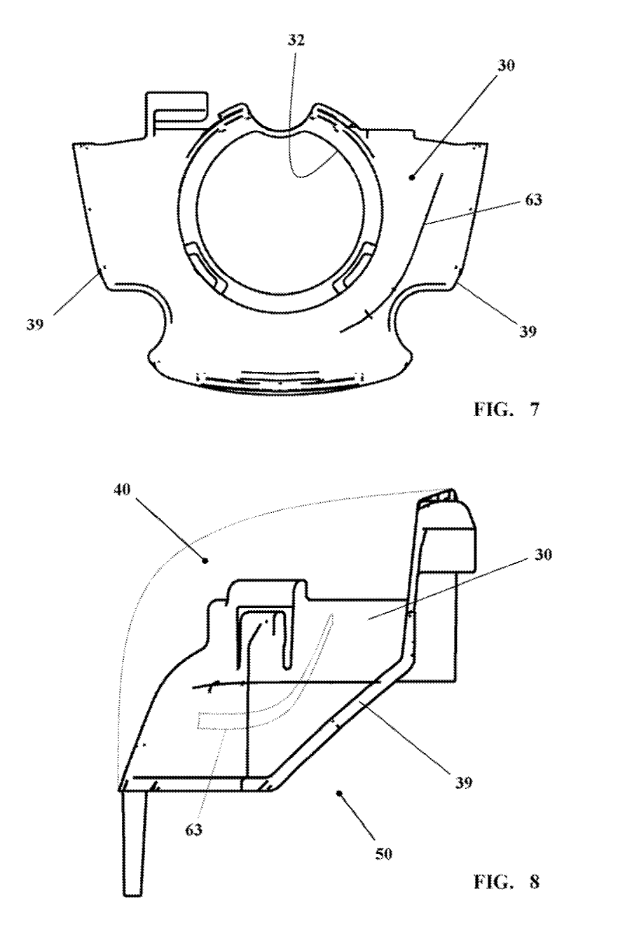

As shown in FIG. 2 through FIG. 6, the electric motor 5 has an air guiding hood 30 that covers the electric motor 5 like a cap or hood. Expediently, the air guiding hood 30 is attached to the electric motor 5. At the bottom 31 of the air guiding hood 30 there is an opening 32 that is matched to the diameter of the electric motor 5 into which the end 29 of the electric motor 5 facing away from the gear 7 is substantially air-tightly inserted.

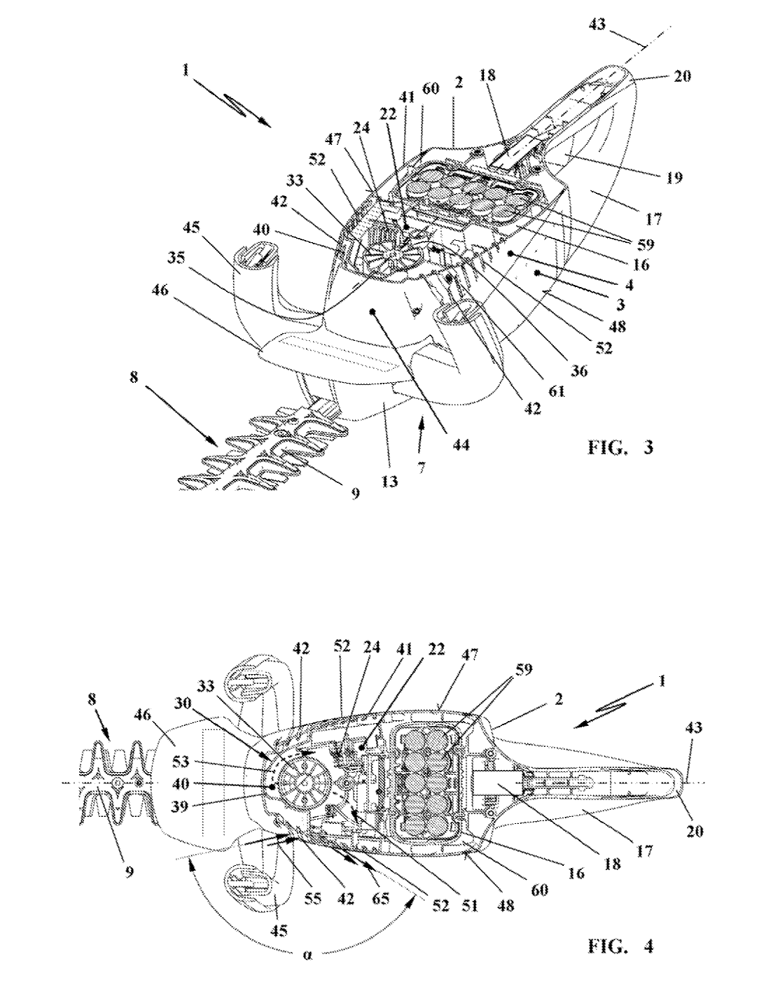

On the end 29 of the electric motor 5, as shown in FIGS. 3 and 4, a blower wheel 33 is secured which is attached to the motor shaft 34 and rotates therewith. The blower wheel 33 sucks in cooling air 55 in the axial direction into the electric motor 5 through an inlet in the form of inlet openings 54 at the end 29 and blows out the air through preferably radial outlet openings 35, 36 in the wall 37 of the motor housing 38. As shown in FIG. 9, one outlet openings 35 is facing forwardly, i.e., is facing the cutter bar 9, while the other outlet opening 36 that is preferably diametrically oppositely positioned relative to the axis of rotation 10 in the motor housing 38 is facing to the rear, i.e., is facing the rear grip 17 of the device housing 2.

The air guiding hood 30 is positioned such in the motor compartment 22 that its edge 39 rests as an inner housing wall on the inner side of the device housing 2, in the illustrated embodiment inside the device housing 2 against the wall of the top housing shell 4.

The shell-like air guiding hood 30 is resting with its entire edge 39 against the upper housing shell 4 so that a cooling air inlet chamber 40 is formed that, on the one hand, is delimited by the air guiding hood 30 and, on the other hand, by the wall 41 of the top housing shell 4 of the device housing 2. In the area of the cooling air inlet chamber 40 in the device housing 2, in the illustrated embodiment in the top housing shell 4, cooling air inlet ports 42 are formed. As shown in FIGS. 3 and 4, the device housing 2 of the hedge trimmer 1 has a longitudinal axis 43 that extends in the direction of the cutter bar 9. The device housing 2 has on the side facing away from the cutter bar 9 a rear grip 17 and in the area of the front end face 44 a front grip 45 embodied as a bow grip. Between the bow grip 45 and the cutter bar 9 there is a hand guard 46.

On each longitudinal side 47, 48 of the device housing 2 a cooling air inlet port 42 is provided so that cooling air flows into the cooling air inlet chamber 40 from both longitudinal sides 47 and 48. This ensures a satisfactory cooling air supply independent of the working conditions.

Below the air guiding hood 30 in the motor compartment 22 a cooling air outlet chamber 50 is provided that, on the one hand, is delimited by the air guiding hood 30 and, on the other hand, by the device housing 2, i.e., the bottom housing shell 3 and the top housing shell 4 as well as the leg 21b of the battery pack support 14. The cooling air outlet chamber 50 is vented through cooling air outlet ports 52 wherein the cooling air outlet ports 52 are preferably formed in the top housing shell 4 of the device housing 2. Correlated with the cooling air inlet ports 42 on each one of the longitudinal sides 47 and 48, a cooling air outlet port 52 is provided on each one of the longitudinal sides 47 and 48 of the device housing, respectively.

In an advantageous embodiment of the invention, the cooling air inlet port 42 and the cooling outlet port 52 form together a common port array 49 in the exterior wall 41 of the device housing 2. This common port array 49 is divided by the air guiding hood 30 or its inner housing wall 39 within the device housing 2 into an inlet port 42 and an outlet port 52. In this connection, the arrangement is expediently such that the blown-out air 51 of the rear outlet opening 36 is correlated with the cooling air outlet port 52 on a first longitudinal side 48 while the blown-out air 53 of the other front outlet opening 35 is deflected by the air guiding hood 30 such to the rear that blown-out air 53 substantially exits through the cooling air outlet port 52 of the second longitudinal side 47 of the device housing 2. Preferably, the outlet openings 35 and 36 each have correlated therewith a cooling air outlet port 52 in the first or the second longitudinal side (47, 48), respectively.

The arrangement is such that the incoming cooling air 55 flows in from the front into the cooling air inlet port 42 located near the bow grip 45 and the outflowing cooling air 65 is oriented in substantially the same flow direction oriented in the direction toward rear grip 17 out of the rear cooling air outlet port 52. In plan view onto the device housing 2, compare FIG. 4, the incoming cooling air 55 and the outflowing cooling air 65 extend at an angle α that is smaller than 180°, preferably is approximately 150° to 90°.

It can be expedient to provide on the cooling air inlet port 42 and/or on the cooling air outlet port 52 guide ribs 61 (FIG. 3) for guiding the flow in order to achieve, for example, that the outflowing heated cooling air cannot be sucked into the cooling air inlet port. Such guide ribs 61 can be arranged on the exterior side as well as on the interior side of the ports 42, 52. In an advantageous further embodiment of the invention, on the air guiding hood 30 guide ribs 63 (FIGS. 7, 8) are provided that may serve for guiding the blown-out air 51, 53 as well as for guiding the incoming cooling air 55 to the intake openings 54 in the end 29 of the electric motor 5.

The cooling air inlet chamber 48 and the cooling air outlet chamber 50 are separated from one another by the inner housing wall 39 of the air guiding hood 30, preferably substantially air-tightly separated from one another, wherein the motor housing 38 of the electric motor 5 provides substantially the only flow connection between the cooling air inlet chamber 40 and the cooling air outlet chamber 50. The structurally provided only distinct flow connection has the goal that substantially the entire cooling air flow passes through this flow connection and possible leakage flows are substantially prevented or are insignificantly small. Leakage or minimal leakage flows may still be permissible inasmuch as no—preferred—increased seal-tightness is provided. In case of such increased seal-tightness, more than 85%, preferably more than 95% up to 99%, of the entire cooling air will pass through the only flow connection.

As illustrated schematically in FIG. 2, in the area of the forward grip 45 cooling air 55 enters via the cooling air inlet ports 42 at both longitudinal sides 47 and 48 of the device housing 2 into the cooling air chamber 40. Through intake openings 54 at the end 29 of the electric motor 5, secured at the bottom 31 of the air guiding hood 30, the cooling air 55 enters the electric motor 5, cools it, and is then blown out through the outlet openings 35 and 36 in the wall 37 of the motor housing 38. In this connection, one stream of blown-out air 51 is directly guided onto the electronic components 56 arranged in the cooling air outlet chamber 50. The electronic components 56 are preferably connected to a heat-dissipating wall 57 that, as a heat exchanger, is positioned in the stream of blown out air 51 of the rear outlet opening 36.

The stream of blown-out air 53 of the front outlet opening 35 is deflected by the wall parts 58 of the air guiding hood 30 (FIG. 4) to the rear and passes across a heat exchanger 24 that is connected in a heat-transmitting way to power electronics.

As shown in FIG. 3, the housing volume of the device housing 2 is substantially determined by the battery pack 16 which is inserted into a corresponding battery pack compartment 60 arranged between the rear grip 17 and the forwardly positioned motor compartment 22. The motor compartment 22 is positioned in a section of the device housing 2 that is located between the bow-shaped front grip 45 and the battery pack compartment 60.

The battery pack 16 of this embodiment is comprised of a plurality of battery cells 59; in the embodiment two layers each comprised of ten cells 59 are provided. The battery cells 59 are preferably rechargeable cells, for example, rechargeable cells such as NiCd cells (nickel cadmium cells), NiMH cells (nickel metal hydride cells), Li-ion cells (lithium ion cells), LiPo cells (lithium polymer cells), LiFePO4 cells (lithium iron phosphate cells), lithium titanate cells or battery cells of a similar build. The battery cells have cell voltage of 2 volts to 5 volts, preferably 3.6 volts to 3.7 volts. With an appropriate electric connection (serial connection, parallel connection), battery pack voltages of 12 volts to 150 volts, preferably 25 volts to 50 volts, can be made available by employing the aforementioned battery cells.

The specification incorporates by reference the entire disclosure of German priority document 10 2009 012 177.3 having a filing date of Feb. 27, 2009.

While specific embodiments of the invention have been shown and described in detail to illustrate the inventive principles, it will be understood that the invention may be embodied otherwise without departing from such principles.

What is claimed is:

1. A hand-guided electric device comprising:
a device housing;
an electric motor arranged in said device housing for driving a working tool, wherein said electric motor comprises a motor housing having an inlet and an outlet for cooling air;
an electronic component controlling said electric motor;
a blower wheel driven by said electric motor;
wherein said electric motor takes in cooling air into said motor housing with said blower wheel through said inlet and blows out cooling air from said motor housing through said outlet;
wherein said device housing has a cooling air inlet chamber and a cooling air outlet chamber;
wherein cooling air enters said cooling air inlet chamber through a cooling air inlet port provided in an exterior housing wall of said device housing and exits from said cooling air outlet chamber through a cooling air outlet port provided in said exterior housing wall of said device housing;
wherein said cooling air inlet chamber and said cooling air outlet chamber are separated from one another substantially air-tightly by an inner housing wall of said device housing and wherein said motor housing forms the only distinct flow connection between said cooling air inlet chamber and said cooling air outlet chamber.

2. The electric device according to claim 1, wherein said cooling air inlet port and said cooling air outlet port form of common port array in said exterior housing wall of said device housing.

3. The electric device according to claim 2, wherein said common port array is divided by said inner housing wall that rests inwardly against said exterior housing wall of said device housing.

4. The electric device according to claim 1, wherein said cooling air inlet chamber is supplied through two of said cooling air inlet ports.

5. The electric device according to claim 1, wherein two said cooling air outlet ports are provided, wherein said outlet of said motor housing comprises a first and a second outlet openings and wherein said first and second outlet openings each have correlated therewith one of said cooling air outlet ports.

6. The electric device according to claim 5, wherein two said cooling air inlet ports are provided, wherein said device housing has a longitudinal axis and said exterior housing wall comprises two opposed longitudinal sides relative to said longitudinal axis, wherein said longitudinal sides each have one of said two cooling air inlet ports and one of said two cooling air outlet ports arranged thereon.

7. The electric device according to claim 5, wherein said two cooling air outlet ports are positioned on opposed first and second longitudinal sides of said exterior wall so that said first outlet opening vents with through said cooling air outlet port on said first longitudinal side and said second outlet opening vents through said cooling air outlet port on said second longitudinal side.

8. The electric device according to claim 1, wherein said device housing is comprised of a bottom housing shell and a top housing shell forming said exterior housing wall, wherein said cooling air inlet port and said cooling air outlet port are disposed in said top housing shell.

9. The electric device according to claim 1, wherein said cooling air inlet chamber is delimited by said exterior housing wall of said device housing and said inner housing wall.

10. The electric device according to claim 1, further comprising an air guiding hood that is attached to said electric motor, wherein said inner housing wall is a part of said air guiding hood.

11. The electric device according to claim 10, wherein said air guiding hood forms a bottom of said cooling air inlet chamber and wherein said inlet of said electric motor is located within said bottom of said air guiding hood.

12. The electric device according to claim 1, comprising a heat exchanger for said electronic component, wherein said heat exchanger is arranged in a flow path of the cooling air between said cooling air inlet port and said cooling air outlet port.

13. The electric device according to claim 12, wherein said heat exchanger is arranged in said cooling air outlet chamber.

14. The electric device according to claim 12, wherein said heat exchanger is arranged in a stream of blown-out air of said outlet of said motor housing.

15. The electric device according to claim 12, wherein said electronic component for controlling said electric motor and said heat exchanger are positioned in a flow path of the cooling air.

16. The electric device according to claim 1, wherein said electronic component for controlling said electric motor is positioned in a flow path of the cooling air.
